(19) United States
(12) Patent Application Publication
(10) Pub. No.: US 2026/0324570 A1
(43) Pub. Date: Oct. 22, 2026

(54) TEXTILE ARRANGEMENT FOR A GREEN ROOF AND SECURING AN OBJECT

(71) Applicant: ZinCo GmbH, Nürtingen (DE)

(72) Inventor: Ralf Walker, Metzingen (DE)

(73) Assignee: ZinCo GmbH, Nürtingen (DE)

(21) Appl. No.: 19/649,548

(22) Filed: Apr. 16, 2026

(30) Foreign Application Priority Data
Apr. 17, 2025 (DE) 102025115246.2

(51) Int. Cl. A01G 27/06; D04H 3/011; D04H 3/016; D04H 3/018; D04H 3/11

(52) U.S. Cl. CPC A01G 27/06; D04H 3/011; D04H 3/016; D04H 3/018; D04H 3/11; D10B 2505/204

(57) ABSTRACT

A textile arrangement for a flat roof provides both a base for continuous irrigation for a planting and a secure fastening for an object being a photovoltaic module. The textile arrangement has a first spacer block connected directly to a second spacer block. On the first spacer block a first textile absorbent is arranged. On the second spacer block the first textile and/or a second textile absorbent is arranged. On the first spacer block, a first holder is screwed in, with which a mounting element of the object is attached to the first spacer block. A plurality of spacer blocks are connected to each other by block connecting means forming a very difficult to lift composite. A substrate can be directly heaped on the first textile and the second textile. The first textile and the second textile extend downwards in portions to irrigate the substrate with accumulated water.

### CROSS-REFERENCE TO RELATED APPLICATIONS

This application claims priority to German Patent Application No. DE 10 2025 115 246.2 filed Apr. 17, 2025, the entire contents of which are hereby incorporated in full by this reference.

### DESCRIPTION

### FIELD OF THE INVENTION

The invention relates to a textile arrangement for a green roof, in conjunction with securing an object. The invention further relates to a flat roof having such a textile arrangement with object securement, and to a method for producing such a textile arrangement with object securement.

### BACKGROUND OF THE INVENTION

It is known to configure a flat roof as a green roof. Often, in addition to the green roof plantings, a further object is to be attached to the flat roof - for example, technical building equipment, in particular, in the form of a photovoltaic module, a fall protection system, an air conditioning system, or the like. To attach such an object, drilling typically needs to be done in the flat roof. However, such drilling is a critical issue for the watertightness of the flat roof, since the flat roof is usually designed with a roof seal that is not to be drilled into.

### SUMMARY OF THE INVENTION

Object of the invention: The object of the invention is therefore to provide a way to securely attach an object to a greenable flat roof.

Description of the invention: This object is achieved according to the invention by a textile arrangement according to claim 1, by a flat roof according to claim 13, and by a method according to claim 14. The dependent claims reflect preferred developments.

The object according to the invention is thus achieved by a textile arrangement for a green roof which has the following features:
a) a first spacer block;
b) a first textile arranged at least partially on the first spacer block;
c) a second spacer block;
d) the first textile and/or a second textile which is/are at least partially arranged on the second spacer block;
e) a holder that holds an object;
f) a first holder connecting means by which the holder is held on the first spacer block.

According to the invention, spacer blocks provided with at least one first textile are used to secure the object. Especially once the textile(s) are covered with substrate and vegetation, the spacer blocks constitute a heavy weight (more than 100 kg/m²), which holds the object. In other words, the first textile, together with the first spacer block, makes it possible to establish a bearing load. The bearing load for anchoring the object remains in place. Therefore, the textile(s) constitute a functional separating layer that, on the one hand, prevents the substrate from trickling downwards and, on the other, allows the absorption of the forces exerted by the object.

A spacer block is understood to be a preferably cuboid, solid body which preferably has a plurality of passage openings to allow water that accumulates on a flat roof to permeate it. A spacer block can be made in a single piece, in multiple pieces, and/or of plastic. A spacer block is preferably designed to distance a textile arranged on it from a base on which the spacer block rests. Therefore, water can be accumulated or stored under the textile using the spacer block. Multiple coupled spacer block blocks enable the desired retention volume.

The top surface of the first spacer block can be polygonal, in particular, rectangular, preferably square. The length and width of the rectangular top surface are preferably between 0.2 m and 2 m, in particular, between 0.4 m and 1.0 m. The vertical thickness of the first spacer block is preferably between 0.05 m and 0.4 m, in particular, between 0.08 m and 0.25 m.

A textile is understood to be a flexible textile structure, especially one in contact with the earth, and particularly in the form of a geotextile. The textile can be rot-proof. The textile should preferably be water-permeable. The textile can be designed in the form of a non-woven. The textile is preferably designed to conduct water to a substrate arranged on the textile for the purpose of irrigating a plant.

The first and second textiles can overlap. Preferably, the overlap is between 5% and 15%. For example, the first textile and the second textile can be 2 m wide and overlap by 20 cm.

The second textile is preferably identical in design to the first textile. Preferably, the textile arrangement has a plurality of textiles - in particular, more than three textiles - which are preferably identical to the first textile.

The second spacer block is preferably identical to the first spacer block. The textile arrangement can have a plurality of spacer blocks - particularly more than three spacer blocks. The spacer blocks are preferably designed identically to the first spacer block.

The object can be part of the textile arrangement.

The terms “above,” “below,” “on,” etc., used here refer to the installed state of the textile arrangement on a flat roof. “On” means “above,” preferably “directly on.”

In a particularly preferred embodiment of the invention, the first holder connecting means is mounted on the first spacer block without reaching around it. In other words, a countermeasure under the first spacer block, e.g., in the form of a cotter pin or nut, is omitted. This allows the holder connecting means to be installed when the first spacer block is already installed on the flat roof. Therefore, the spacer blocks can be installed on the flat roof, and then the first holder connecting means can be installed. This makes the workflow for creating a green roof both more flexible and simpler.

The first holder connecting means can be in the form of a bolt, in particular, with a connecting means for forming a bayonet connection.

The first holder connecting means can be designed in the form of a screw. Preferably, the screw is designed in the form of a self-tapping screw. A screw-based holder connecting means significantly simplifies the mounting of the holder.

The first spacer block may have a tube (sleeve) to accommodate the first holder connecting means.

Preferably, the first spacer block has a plurality of tubes connected to each other by webs. The first spacer block, via its tubes, offers a plurality of stable attachment points for the first holder connecting means.

The textile arrangement may have a block connecting means by which the second spacer block is connected to the first spacer block. The block connecting means can, for example, be designed in the form of a latching connection on the first spacer block and the second spacer block.

Preferably, the block connecting means is designed separately from the first spacer block and separately from the second spacer block.

The block connecting means can be designed in the shape of a bow tie. The block connecting means can, in particular, have two dovetails on opposite ends. The first spacer block and the second spacer block can each have a cutout that tapers towards the edge of the spacer block, and the block connecting means can be inserted into this cutout. The block connecting means, the first spacer block and the second spacer block are preferably designed such that the two spacer blocks are clamped against each other when the block connecting means is inserted into the cutouts. This prevents substrate from trickling into a gap between the spacer blocks.

The first textile can have a spacer passage opening and the second textile can have a further spacer passage opening to easily connect the first spacer block to the second spacer block.

The textile arrangement may have a further spacer block, which is connected to the first spacer block indirectly or directly via one or more block connecting means of the textile arrangement. The textile arrangement may have an additional holder connecting means that holds the holder to the additional spacer block. The additional spacer block can be designed in the form of the second spacer block. The additional holder connecting means can be designed in the form of a second holder connecting means on the second spacer block. In other words, the additional holder connecting means (in the form of the second holder connecting means) can be located on the spacer block (the second spacer block) that is immediately adjacent to the first spacer block, or the additional holder connecting means can be located on a more distant, additional spacer block.

Preferably, more than three spacer blocks, in particular, more than eight spacer blocks, and especially preferably more than twelve spacer blocks, are connected together. This greatly increases the leverage required to lift the spacer block composite, which can be caused, in particular, by wind loads on the object, so that the object is particularly securely fastened.

The holder may have a rail that extends across multiple spacer blocks. The rail allows for a significant stiffening of the spacer block composite, thereby also increasing the leverage required to hold down the spacer block composite.

The first textile, and, in particular, the second textile, may each have cross-linked microfilaments that consist at least partially of polyester.

The polyester can be in the form of polyethylene terephthalate (PET).

The first textile can be composed of more than 70%, and, in particular, more than 90%, polyester.

The microfilaments can be interconnected without solvents or binders. This makes the first textile easier to recycle.

The first textile can consist of microfilaments, making it particularly absorbent.

The first textile preferably extends downwards along multiple end faces of the first spacer block in order to reach into the water. The first textile particularly preferably extends downwards along all end faces of the first spacer block.

The end faces preferably extend between the larger top surface and the larger bottom surface of the first spacer block. The first textile preferably extends downwards on the end face(s) all the way to the bottom surface.

The first textile can be cut to size, particularly in the shape of the spacer block, with a flap on each side. This allows the first textile to be easily arranged on the first spacer block.

In a particularly preferred embodiment of the invention, the microfilaments are star-shaped or pizza-shaped in cross-section (circular overall, with triangular individual pieces). In these cases, the first textile exhibits particularly strong capillary forces.

If the microfilaments are made of two components, they can be spliced to create particularly large volumes.

Particularly preferably, the first textile can have polyester and polyamide (PA), especially in the form of polyamide 6, and can preferably consist of polyester and PA.

The microfilaments preferably have a thickness between 100 nm and 500 nm. In a further preferred embodiment of the invention, the microfilaments have a fineness between 0.01 dtex and 1 dtex.

The first textile can have a passage opening, wherein the textile arrangement has a fastening means, e.g., a pin, which is passed through a passage opening of the first textile and fixed to the first spacer block. This allows a unit consisting of the first spacer block and the first textile to be easily laid on the flat roof.

The passage opening can be in the form of a borehole or at least a slot - for example, a cross-slot.

The passage opening can be formed in the middle of the first textile to effectively prevent the first textile from slipping on the first spacer block.

Furthermore, the first textile is preferably designed to be drill-resistant, so that it can be easily worked with cutting tools without getting stuck on the tool.

To further increase the absorbency or capillarity of the textile arrangement, the first textile can be provided on one or both sides with a film spaced apart from the microfilaments by a narrow gap. The film can have polyester, and, in particular, can be made of polyester.

The object is preferably designed in the form of a part of technical building equipment, in particular, in the form of a photovoltaic module, a heat pump part (e.g., a heat pump outdoor part), an air conditioning part (e.g., an air conditioning outdoor part), a ventilation pipe, a fan, an elevator part, a fall protection device and/or a railing.

The textile arrangement may have a substrate for growing a plant, which is arranged on the first textile, and especially on the second textile. A mixture of pumice, lava, and compost, for example, can be used as a substrate. The substrate is preferably blowable.

In a particularly preferred embodiment of the invention, the substrate is arranged directly on the first textile and the second textile. By eliminating the need for a flexible textile structure (“filter fleece”) between the first textile and the second textile on the one hand, and the substrate on the other, the substrate can be irrigated in a particularly efficient manner with a simple overall structure.

A further embodiment of the invention omits the irrigation function. A first textile in the form of a filter fleece, preferably in the form of a geotextile, is laid flat on the spacer elements, which are, in particular, already connected to each other. This is preferably designed to be drill-resistant, so that fastening means can be easily inserted.

The invention further relates to a flat roof with a textile arrangement described herein.

It is particularly advantageous for a flat roof surface to be completely or almost completely covered with connected spacer blocks. This effectively prevents the spacer block composite from slipping.

Finally, the invention relates to a method for producing a textile arrangement described herein, having the following method steps:

D) cutting the first textile and particularly the second textile to size;

E) arranging the first textile on the first spacer block and arranging the first textile and/or second textile on the second spacer block;

G) fastening the holder to the first spacer block using the first holder connecting means;

H) fastening the object to the holder;

I) applying, in particular, by blowing, the substrate to the first textile and, in particular, to the second textile.

Fastening the object to the holder after the substrate has already been applied allows for easy application of the substrate over a large area.

Between method steps E and G, in a method step F, the first spacer block can be connected to the second spacer block using a block connecting means described here.

The following method steps may precede method step D):
A) spinning continuous filaments;
B) laying the continuous filaments on a web;
C) splitting and solidifying the continuous filaments with high-pressure water jets to form the cross-linked microfilaments in the form of a textile, wherein in method step
D) the first textile, and particularly the second textile, is cut to size from this textile.

Before, after or between method steps A) to I), a further method step or further method steps can be carried out.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1 schematically shows a side view of a flat roof having a textile arrangement, wherein the textile arrangement has two spacer blocks connected to each other, on each of which a textile is arranged as a substrate carrier for a green roof.

FIG. 2a is a perspectival view of a first textile cut to size.

FIG. 2b is a plan view of the textile of FIG. 2a.

FIG. 3 is a top view of a textile arrangement, wherein a first spacer block is covered with a first textile and a second spacer block is not covered with a textile, in order to better illustrate the connection of the two spacer blocks.

FIG. 4 is a perspectival view of a textile arrangement having a first spacer block, a first textile arranged on it, and a holder.

FIG. 5 is a scanning electron microscopy image of a first textile at 50x magnification, in which microfilaments of the first textile can be seen.

FIG. 6 is a further enlarged perspectival view of some of the microfilaments of FIG. 5.

FIG. 7 shows method steps for manufacturing a textile arrangement.

### DETAILED DESCRIPTION OF THE PREFERRED EMBODIMENTS

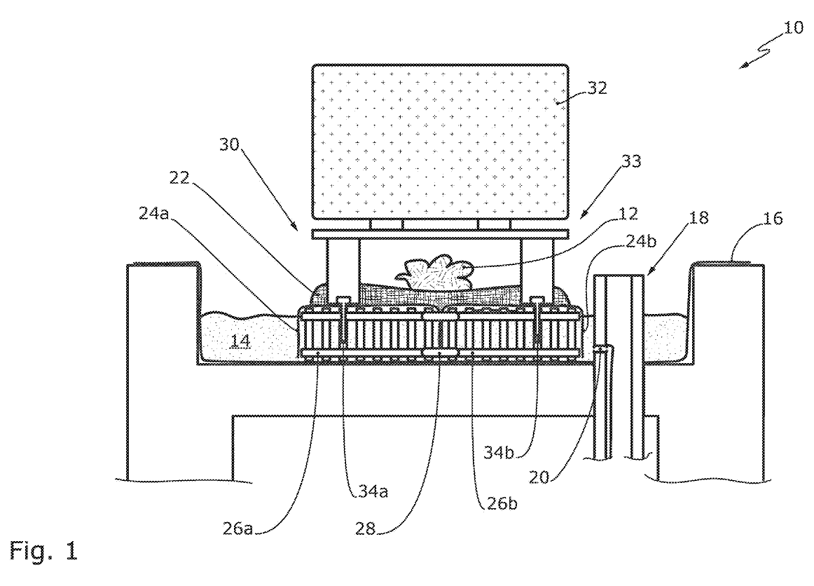

FIG. 1 shows a flat roof 10 planted with a plant 12. In order to irrigate the plant 12 as continuously as possible, water 14 is stored on the flat roof 10. For this purpose, a seal 16 is installed on the flat roof 10 - made particularly of bitumen or plastic. A drain 18 with a collection device is arranged in an elevated position to dam the water 14. Preferably, a throttle 20 is installed on the drain 18, in particular, in the form of a controllable throttle, provided to enable a controlled outflow of the water 14 for managing heavy rain.

The plant 12 is rooted in a substrate 22. The substrate 22 is arranged on a first textile 24a and a second textile 24b. Preferably, the substrate 22 is arranged directly (without any further intermediate layer) on the first textile 24a and the second textile 24b. This simplifies the overall design and installation.

The first textile 24a lies on the top surface of a first spacer block 26a; the second textile 24b lies on the top surface of a second spacer block 26b. The spacer blocks 26a, b are designed to be water-permeable.

The spacer blocks 26a, b are connected by multiple block connecting means, a first of which is designated by the reference sign 28. The block connecting means 28 clamp the spacer blocks 26a, b to each other, so that no substrate 22 falls into a gap between the first textile 24a and the second textile 24b.

The first textile 24a and the second textile 24b are preferably identical in design. The spacer blocks 26a and 26b are also preferably identical in design.

The first textile 24a and the second textile 24b are preferably designed to be absorbent in order to transport the water 14 to the substrate 22, where it can be absorbed by the plant 12. A textile arrangement 30 comprised of the spacer blocks 26a, b and the textiles 24a, 24b thus enables irrigation of the plant 12 over a long period of time.

In the present case, the textile arrangement 30 further serves to hold an object 32. The object 32 can be in the form of a building technology device - for example, a heat pump component or an air conditioning component. Alternatively, the object can be designed in the form of a fall protection device or – as shown in FIG. 1 – a photovoltaic module.

The object 32 is mounted via a holder 33 on the spacer blocks 26a, b, wherein the holder 33 is fastened via a first holder connecting means 34a to the first spacer block 26a and via a second holder connecting means 34b to the second spacer block 26b. The holder connecting means 34a, b can each be in the form of a screw, in particular, in the form of a self-tapping screw. The holder connecting means 34a, b particularly preferably do not engage around the spacer blocks 26a, b (as shown in FIG. 1), such that they are particularly easy to install.

The substrate 22 is particularly preferably blown on when the holder connecting means 34a, b are installed, but the object 32 and the holder 33 are not yet installed. Therefore, the installation steps can be decoupled according to the invention, by virtue of the holder connecting means 34a, b being initially installed by themselves. In this case, substrate 22 can be applied particularly easily, especially by blowing it on. Then, the holder 33 and the object 33 can be installed.

Due to the (indirect) connection of the object 32 to the spacer blocks 26a, b, the object 32 no longer necessarily needs to be attached to another part of the building. In particular, the film 16 does not need to be pierced in order to attach the object 32.

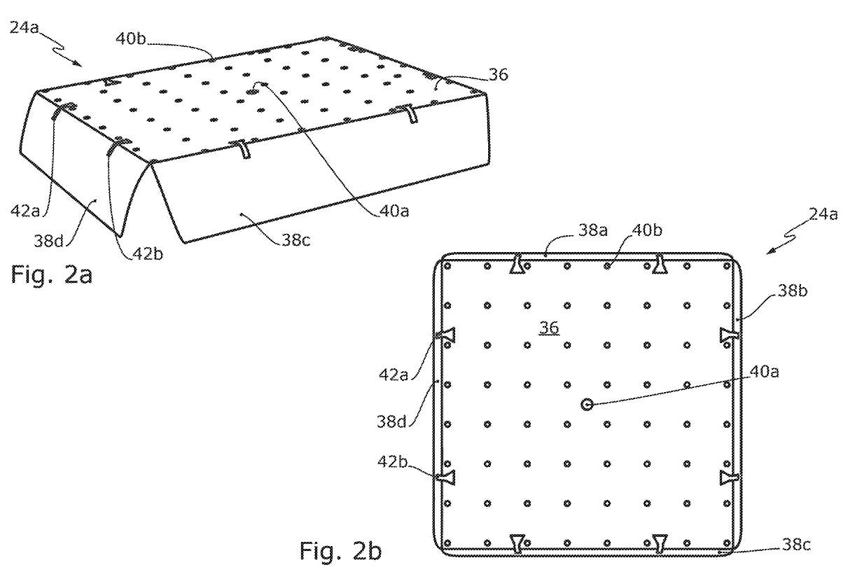

FIGS. 2a, 2b show an embodiment of a first textile 24a. The first textile 24a preferably has a rectangular shape, in particular – as shown in FIGS. 2a, b – a square top surface 36. The top surface 36 is connected to side flaps 38a, 38b, 38c, 38d, in particular, in one piece. In the installed state of the textile arrangement 30 (see FIG. 1), the side flaps 38a-d protrude downwards to be able to absorb accumulated water (see FIG. 1 at reference signs 24a, b).

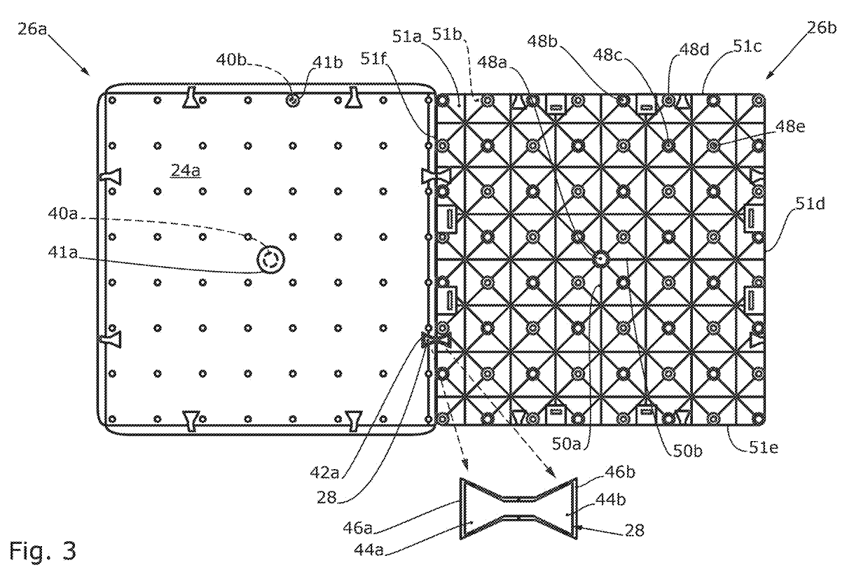

The first textile 24a has multiple passage openings and/or markings, of which in FIGS. 2a, b two are designated by reference signs 40a, 40b. A fastening means, e.g., a pin or a screw, can be guided through each of the passage openings or markings 40a, b, to fix the first textile 24a to the first spacer block 26a (see FIG. 3). FIG. 3 shows two fastening means 41a, 41b, which are guided into the passage openings or markings 40a, b. If the first textile 24a is fixed to the first spacer block 26a, such a textile arrangement 30 (see FIG. 1a) can be made particularly compact and easy to install.

The passage opening(s) or marking(s) 40a, b can be in the form of embossings, slots or boreholes, or alternatively in the form of lettering. Preferably, the first textile 24a has a central passage opening (here, 40a) in the center of the top surface 36 (see FIG. 2b). This allows the first textile 24a to be held in a particularly positionally-accurate manner on the first spacer block 26a.

The first textile 24a furthermore has multiple spacer passage openings, of which two are designated by the reference signs 42a, 42b in FIGS. 2a, b. The spacer passage openings 42a, b serve to facilitate the connection of two adjacent spacer blocks 26a, b (see FIG. 1). This will be explained in more detail below in connection with FIG. 3.

FIG. 3 shows a first spacer block 26a and a second spacer block 26b. A first textile 24a is arranged on the first spacer block 26a. A second textile, which is actually arranged on the second spacer block 26b, is hidden in FIG. 3 in order to improve the explanation of the connection between the spacer blocks 26a, b.

The two spacer blocks 26a, b are connected via multiple block connecting means, of which one block connecting means 28 is shown in FIG. 3. The block connecting means 28 is shaped like a bow tie or like the letter I. It has opposing, connected dovetails 44a, 44b. The block connecting means 28 is preferably formed in one piece.

The block connecting means 28 locks into cutouts 46a, 46b of the spacer blocks 26a, b which taper towards the edge of the spacer blocks 26a, b. The block connecting means 28 passes through the spacer passage opening 42a of the first textile 24a.

FIG. 3 shows that the second spacer block 26b (like the first spacer block 26a) has a plurality of tubes running vertically, of which five tubes 48a, 48b, 48c, 48d, 48e are marked with a reference sign in FIG. 3. The central tube 48a is aligned with the passage opening 40a (see FIG. 2a); the tube 48b is aligned with the passage opening or marking 40b (see FIG. 2a). Preferably, multiple tubes 48a-e are each aligned with a passage opening or marking 40a, b, in particular, most tubes 48a-e, particularly preferably all tubes 48a-e.

The tubes 48a-e can have the same diameter or different diameters. In the present case, the tubes 48b and 48c have the same diameter, and the tubes 48d and 48e also have the same diameter. The second spacer block 26b has a grid pattern of tubes of a first diameter (here, for example, with tubes 48b, c). Furthermore, the second spacer block 26b has an offset grid pattern of tubes of a second diameter (here, for example, with tubes 48d, e). The tubes 48a-e are connected by webs, of which the webs 50a, 50b are designated with reference signs in FIG. 3.

The tubes 48a-e preferably have their openings on the top surface 51a and/or the bottom surface 51b of the second spacer block 26b. Between the top surface 51a and the bottom surface 51b, which constitute the large main faces of the second spacer block 26b, run the end faces 51c, 51d, 51e, 51f of the second spacer block 26b. The end faces 51c-f preferably extend perpendicularly to the longitudinal direction of the webs 50a, b and parallel to the longitudinal direction of the tubes 48a-e.

The second spacer block 26b can be made in one piece, particularly from plastic.

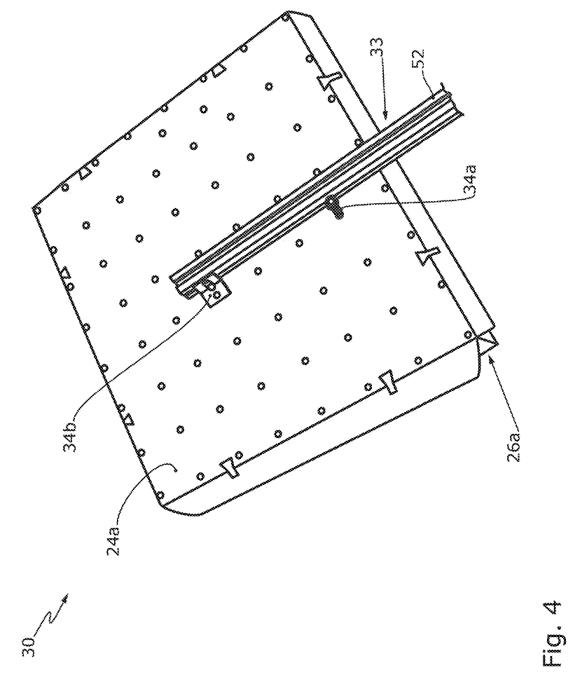

FIG. 4 shows a textile arrangement 30 having a first spacer block 26a on which a first textile 24a is arranged. A holder 33 has a rail 52 which extends over multiple spacer blocks (in FIG. 4, only a first spacer block 26a is shown). The holder 33 is attached to the first spacer block 26a via multiple holder connecting means 34a (here in the form of a screw), 34b (here in the form of a mounting bracket). The rail 52 leads to a stiffening of multiple spacer blocks (not shown in FIG. 4), making it more difficult to lift or lever them up. An object 32 (see FIG. 1) is thus more securely fastened. The rail 52 can be designed in the form of a profile rail with a cross-section of the same length along its longitudinal axis.

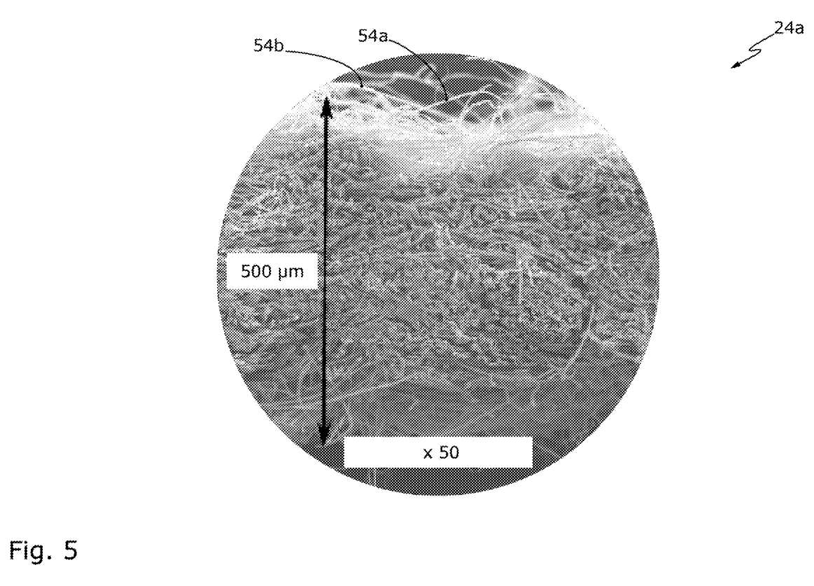

FIG. 5 shows a greatly enlarged image of a first textile 24a. FIG. 5 shows that the first textile 24a has a plurality of microfilaments, of which only two microfilaments 54a, 54b are provided merely by way of example with reference signs in FIG. 5. Preferably, the first textile 24a – as in the present case – consists exclusively of microfilaments 54a, b.

The first textile 24a can have a thickness between 0.1 mm and 3 mm, in particular, between 0.2 mm and 2 mm, preferably (as shown) between 0.4 mm and 1 mm.

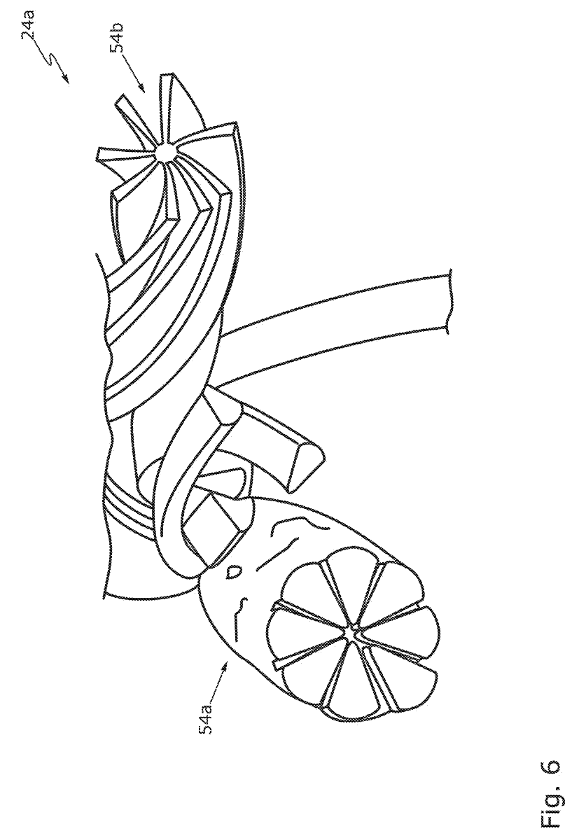

FIG. 6 shows a further enlarged image of the first textile 24a. According to FIG. 6, the microfilament 54a has a cross-section in the shape of a pizza with multiple pizza slices, and the microfilament 54b has a star-shaped cross-section. The microfilaments 54a, b are preferably made of PET, in particular, predominantly of PET, and PA. The first textile 24a generates exceptionally high capillary forces in water and enables water flow rates of more than 4 L/m² daily.

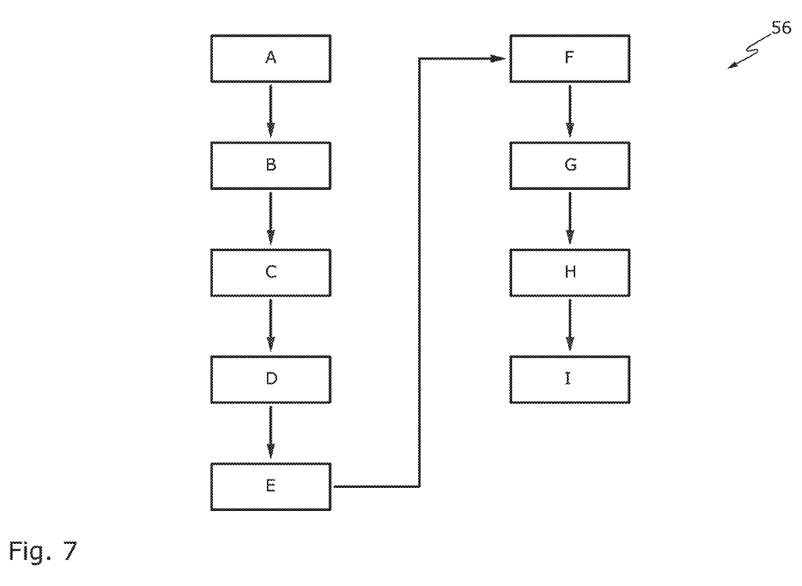

FIG. 7 shows a method 56 for producing a textile arrangement 30 according to the drawings, having the method steps of:
A) spinning continuous filaments;
B) laying the continuous filaments on a web;
C) splitting and solidifying the continuous filaments with high-pressure water jets to form the cross-linked microfilaments 54a, b in the form of a textile;
D) cutting the textile into a first textile 24a and a second textile 24b;
E) arranging the first textile 24a on a first spacer block 26a and arranging the second textile 24b on a second spacer block 26b;
F) connecting the spacer blocks 26a, b with a block connecting means 28;
G) fastening a holder 33 to the first spacer block 26a by means of a first holder connecting means 34a;
H) applying the substrate 22 to the first textile 24a and the second textile 24b;
I) fastening an object 32 to the holder 33.

Applying, in particular, by blowing, the substrate 22 before installing the object 32 significantly simplifies the processes for the flat roof planting 10. This is because, without the object 32, the substrate 22 can be applied easily and quickly over a wide area, especially through a hose (not shown).

Taking an overview of all the figures of the drawing, the invention relates in summary to a textile arrangement 30 for a flat roof 10. The textile arrangement 30 provides both a base, in particular, for a continuous irrigation for a planting, and also a secure mount for an object 32 - for example, a photovoltaic module. The textile arrangement 30 comprises at least a first spacer block 26a and a second spacer block 26b, which are preferably connected via a block connecting means 28, in particular, directly. A first textile 24a, which is in particular, absorbent, is arranged on the first spacer block 26a, and the first textile 24a and/or a second textile 24b, in particular, absorbent, is arranged on the second spacer block 26b. On the first spacer block 26a, a first holder connecting means 34a is arranged, in particular, screwed in, with which a holder 33 of the object 32 is attached to the first spacer block 26a. Preferably, a plurality of spacer blocks 26a, b are connected to each other by block connecting means 28 to form a very difficult to lift composite (rigid surface disk). A substrate 22 can be directly piled on the first textile 24a and the second textile 24b, wherein the first textile 24a and the second textile 24b preferably protrude downwards in portions in order to irrigate the substrate 22 with accumulated water.

### LIST OF REFERENCE SIGNS

10 flat roof

12 plant

14 water

16 film

18 drain with accumulation device

20 throttle

22 substrate

24a first textile

24b second textile

26a first spacer block

26b second spacer block

28 block connecting means

30 textile arrangement

32 object

33 holder

34a first holder connecting means

34b second holder connecting means

36 top surface

38a-d side flap

40a, b passage opening or marking

41a, b fastening means

42a, b spacer passage opening

44a, b dovetail

46a, b cutout

48a-e tubes

50a, b webs

51a top surface

51b bottom surface

51c-f end faces

52 rail

54a, b microfilament

56 method

What is claimed is:

1. A textile arrangement for a green roof, comprising:
a) a first spacer block;
b) a first textile on the first spacer block;
c) a second spacer block;
d) the first textile and/or a second textile on the second spacer block;
e) a holder on which an object is held;
f) a first holder connecting means by which the holder is held on the first spacer block.

2. The textile arrangement according to claim 1, wherein the first holder connecting means is designed in the form of a screw.

3. The textile arrangement according to claim 1, wherein the first spacer block has a tube for accommodating the first holder connecting means.

4. The textile arrangement according to claim 3, wherein the first spacer block has a plurality of tubes which are connected to each other via webs.

5. The textile arrangement according to claim 1, wherein the textile arrangement has a block connecting means, wherein the second spacer block is connected to the first spacer block by the block connecting means.

6. The textile arrangement according to claim 5, wherein the block connecting means is designed in the form of a component separate from the first spacer block and the second spacer block.

7. The textile arrangement according to claim 6, wherein the block connecting means is shaped like a bow tie.

8. The textile arrangement according to claim 1, having a further spacer block, which is connected indirectly or directly to the first spacer block via a block connecting means or multiple block connecting means of the textile arrangement, wherein the textile arrangement has a further holder connecting means with which the holder is held on the further spacer block.

9. The textile arrangement according to claim 1, wherein the holder has a rail extending over multiple spacer blocks.

10. The textile arrangement according to claim 1, wherein the first textile and the second textile have cross-linked microfilaments which consist at least partially of polyester.

11. The textile arrangement according to claim 1, wherein the object is designed in the form of a part of technical building equipment, being in the form of a photovoltaic module, a heat pump part, an air conditioning part, a ventilation pipe, a fan, an elevator part, a fall protection device and/or a railing.

12. The textile arrangement according to claim 1, wherein a substrate of the textile arrangement for growing a plant is arranged on the first textile and on the second textile.

13. A flat roof having the textile arrangement according to claim 1.

14. A method for producing the textile arrangement according to claim 12, having the method steps of:
A) cutting the first textile and particularly the second textile to size;
B) arranging the first textile on the first spacer block and arranging the first textile and/or the second textile on the second spacer block;
C) fastening a holder to the first spacer block by means of a first holder connecting means;
D) applying the substrate to the first textile and in particular to the second textile;
E) fastening the object to the holder.

15. The method according to claim 14, wherein the textile arrangement has a block connecting means, wherein the second spacer block is connected to the first spacer block by the block connecting means, and having the following method step between method steps B and C:
F) connecting the spacer blocks with a block connecting means.
